(19) United States
(12) Patent Application Publication
(10) Pub. No.: US 2007/0157178 A1
(43) Pub. Date: Jul. 5, 2007

(54) Cross-module program restructuring

(75) Inventors: Alex Kogan, Haifa (IL); Yaakov Yaari, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/325,655

(22) Filed: Jan. 4, 2006

(51) Int. Cl. G06F 9/44

(52) U.S. Cl. 717/130

(57) ABSTRACT

A computer-implemented method for code optimization includes collecting a profile of execution of an application program, which includes a target module, which calls one or more functions in a source module. The source and target modules may be independently-linked object files. Responsively to the profile, at least one function from the source module is identified and cloned to the target module, thereby generating an expanded target module. The expended target module is restructured so as to optimize the execution of the application program.

### FIELD OF THE INVENTION

The present invention relates generally to optimization of computer code to achieve faster execution, and specifically to optimizing object code following compilation and linking of the code.

### BACKGROUND OF THE INVENTION

Post-link code optimizers generally perform global analysis on the entire executable code of a program module, including statically-linked library code. (In the context of the present patent application and in the claims, the term “module” refers to a single, independently-linked object file.) Since the executable code will not be re-compiled or re-linked, the post-link optimizer need not preserve compiler and linker conventions. It can thus perform aggressive optimizations across compilation units, in ways that are not available to optimizing compilers. Additionally, a post-link optimizer does not require the source code to enable its optimizations, allowing optimization of legacy code and libraries where no source code is available.

Post-link optimization may be based on runtime profiling of the linked code. The use of post-link runtime profiling as a tool for optimization and restructuring is described, for example, by Haber et al., in “Reliable Post-Link Optimizations Based on Partial Information,” Proceedings of Feedback Directed and Dynamic Optimizations Workshop 3 (Monterey, Calif., December, 2000), pages 91-100; by Henis et al., in “Feedback Based Post-Link Optimization for Large Subsystems,” Second Workshop on Feedback Directed Optimization (Haifa, Israel, November, 1999), pages 13-20; and by Schmidt et al., in “Profile-Directed Restructuring of Operating System Code,” IBM Systems Journal 37:2 (1998), pages 270-297.

Various methods of profile-based post-link optimization are known in the art. For example, Cohn and Lowney describe a method of post-link optimization based on identifying frequently executed (hot) and infrequently executed (cold) blocks of code in functions in “Hot Cold Optimizations of Large Windows/NT Applications,” published in Proceedings of Micro 29 (Research Triangle Park, North Carolina, 1996). Hot blocks of code in hot functions are copied to a new location, and all calls to the function are redirected to the new location. The new function is then optimized at the expense of paths of execution that pass through the cold path.

As another example, Muth et al. describe the link-time optimizer tool “alto” in “alto: A Link-Time Optimizer for the Compaq Alpha,” published in Software Practice and Experience 31 (January 2001), pages 67-101. Alto exploits the information available at link time, such as content of library functions, addresses of library variables, and overall code layout, to optimize the executable code after compilation.

In the patent literature, U.S. Patent Application Publications 2004/0015927 and 2004/0019884 describe post-link optimization methods for profile-based optimization. One of these methods involves removing non-volatile register store and restore instructions from a hot function when the non-volatile register is referenced only in cold sections of code within the hot function. In another method, cold caller functions of a hot callee function are identified, and the store and restore instructions with respect to non-volatile registers are “percolated” from the callee function to the caller function. These methods require that the hot functions be disassembled, but do not require the full control flow graph.

### SUMMARY OF THE INVENTION

Embodiments of the present invention provide computer-implemented methods, apparatus and softwaree products for code optimization. An exemplary method includes collecting a profile of execution of an application program, which includes a target module, which calls one or more functions in a source module. The source and target modules may be independently-linked object files. Responsively to the profile, at least one function from the source module is identified and cloned to the target module, thereby generating an expanded target module. The expanded target module is restructured so as to optimize the execution of the application program.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for post-link, cross-module code optimization, in accordance with an embodiment of the present invention;

FIG. 2 is a flow chart that schematically illustrates a method for code optimization, in accordance with an embodiment of the present invention;

FIGS. 3-5 are block diagrams that schematically illustrate steps in a process of code optimization, in accordance with an embodiment of the present invention;

FIG. 6 is a flow chart that schematically illustrates a method for cloning functions from a source module into a target module, in accordance with an embodiment of the present invention;

FIG. 7 is a flow chart that schematically illustrates a method for fixing code upon cloning a function from a source module into a target module; and

FIG. 8 is a program listing that shows an exemplary code segment following optimization, in accordance with an embodiment of the present invention.

### DETAILED DESCRIPTION OF EMBODIMENTS

### Overview

Software applications commonly comprise an executable program together with shared libraries used by the program. Such shared libraries, also called dynamically-linked libraries (DLLs), are provided as post-linked object files. Both the executable program (which may be referred to simply as an “executable”) and the shared libraries are referred to herein as modules (or objects). The modules are linked separately, and the executable uses the shared libraries at runtime. Shared libraries of this sort have the advantages of modularity, manageability, and reduction in memory and disk use, in comparison with statically-linked libraries, which are linked together with the executable before runtime. Shared libraries are commonly produced and made available by operating system vendors and other software providers, thus helping application developers to shorten development time and permit their applications to run on different platforms.

Separation of the application into modules in this manner, however, creates boundaries across which current post-link optimization methods, such as those described in the Background of the Invention, do not operate. The embodiments of the present invention that are described hereinbelow extend the scope of optimization from a single module to the different modules of the application, thus permitting cross-module optimization.

In the disclosed embodiments, a post-link optimizer collects a profile of execution of an application program, which comprises a target module and one or more source modules. Typically (although not necessarily), the target module is an executable object file, while the source modules comprise object files in one or more shared libraries, which may or may not be executable. During execution of the application, the target module calls one or more functions in a source module. Based on the profile, the optimizer identifies and clones at least one of the called functions from the source module into the target module. “Cloning” in this context refers to copying the function in conjunction with code changes that are needed to maintain proper operation of the application after copying. Typically, “hot” functions, which are called relatively frequently during execution, are copied, while “cold” functions are left in the source module. The expanded target module that is created by copying functions from the source module is then restructured so as to optimize the execution of the application program.

Embodiments of the present invention thus allow various post-link optimization techniques, which are currently applicable only within a single module, to be used across different modules, thus producing more optimized results in multi-module applications. As a consequence, even a small main program using few large libraries can be optimized, by copying the hot library functions into the main program. Once the code has been expanded, with the selected functions copied into the target module, intra-module optimizations known in the art, such as code reordering and function inlining, can then be used to enhance runtime performance.

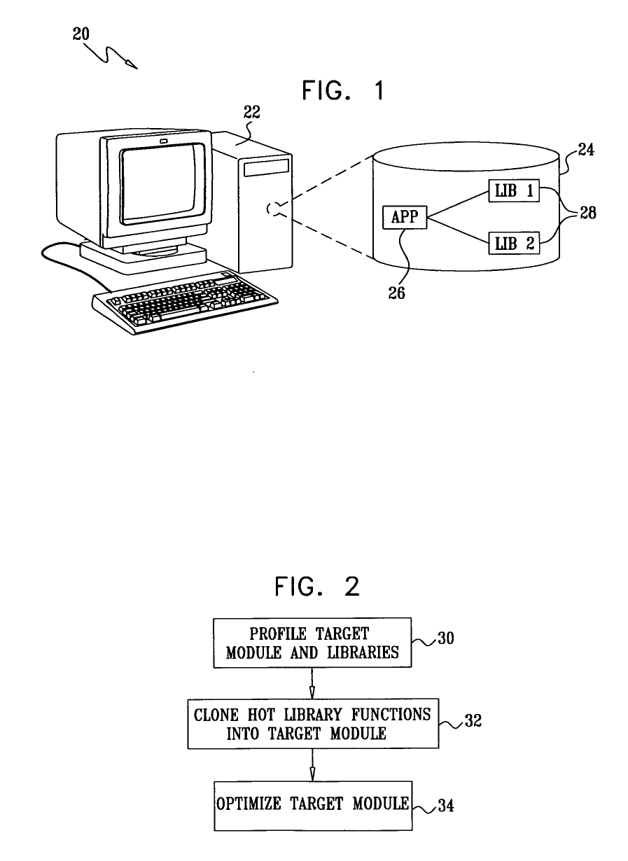

FIG. 1 is a block diagram that schematically illustrates a system 20 for post-link optimization of program code, in accordance with a preferred embodiment of the present invention. System 20 comprises a code processor 22, typically comprising at least one general-purpose computer processor, which is programmed to carry out the functions described hereinbelow. The processor performs these functions under the control of software supplied for this purpose. The software may be downloaded to the processor in electronic form, over a network, for example, or it may alternatively be provided on tangible media, such as optical, magnetic or non-volatile electronic memory media. Alternatively or additionally, at least some of the functions described hereinbelow may be carried out by dedicated or programmable hardware components. Although in the embodiments described hereinbelow, processor 22 is described as carrying out all the code optimization functions, in practice these functions may be divided up among a number of different computers or other processors.

Processor 22 typically accesses and optimizes program code that is stored in a memory 24, which may comprise random access memory (RAM) or a hard disk, for example. Before carrying out the post-link optimization steps described hereinbelow, each of the code modules is compiled and linked, as is known in the art. In the example shown here, the code comprises a main application program 26 (also referred to simply as application 26) and shared libraries 28 (labeled LIB1 and LIB2), which have been compiled and linked independently of one another. In the description that follows, application 26 serves as an exemplary target module for optimization, while libraries 28 serve as source modules.

Application 26 and libraries 28 are assumed to obey a certain application binary interface (ABI) specification, which includes a suitable object file format (OFF), such as the Linux Executable and Linking Format (ELF) for the IBM PowerPC™ (32- or 64-bit version, referred to respectively as ELF32 and ELF64). Because cross-module restructuring deals with the way functions call each other and access data across modules, the choice of file format and the associated machine architecture are important factors in the detailed operation of system 20. For the sake of clarity and completeness, the embodiments described hereinbelow relate to specific examples taken mainly from ELF64. Extension of the principles of these embodiments to other ABIs and file formats will be apparent to those skilled in the art.

The memory image of an ELF64 loadable module comprises code, data, and BSS (below stack segment) segments. The data segment includes a Table Of Contents (TOC), while the BSS includes the Procedure Linkage Table (PLT). The TOC contains pointers to all global data structures in the module, while the PLT contains descriptors for Out-Of-Module (OOM) functions. The TOC is referenced by an anchor register, which provides the module with context for both data and code access by acting as the base register for accessing the function descriptors in the PLT and pointers to data structures in the TOC. The ELF64 linker adds PLT stubs that connect caller sites in the code segment to OOM functions through the PLT-resident descriptors. This facility allows a decision to be made at link-time whether to link the caller site directly to a local function or indirectly, through the stub, to the OOM function. In an embodiment of the present invention that is described in detail hereinbelow, the TOC and PLT are used to establish access to functions and data across modules as the functions are imported from their original module into the target module.

The principles of ELF are described further in a document entitled Tool Interface Standard (TIS) Executable and Linking Format (ELF) Specification, version 1.2 (TIS Committee, May, 1995), which is available at x86.ddj.com/ftp/manuals/tools/elf.pdf. ELF64 is described in detail by Taylor in 64-bit PowerPC ELF Application Binary Interface Supplement 1.7 (IBM Corporation, September, 2003), which is available at www.linuxbase.org/spec/ELF/ppc64/PPC-elf64abi-1.7.pdf. ELF32 is described by Zucker et al., in System V Application Binary Interface: PowerPC Processor Supplement (Sun Microsystems, September, 1995), which is available at www.linuxbase.org/spec/refspecs/elf/elfspec_{—ppc.pdf.}

### Method for Post-Link Code Optimization

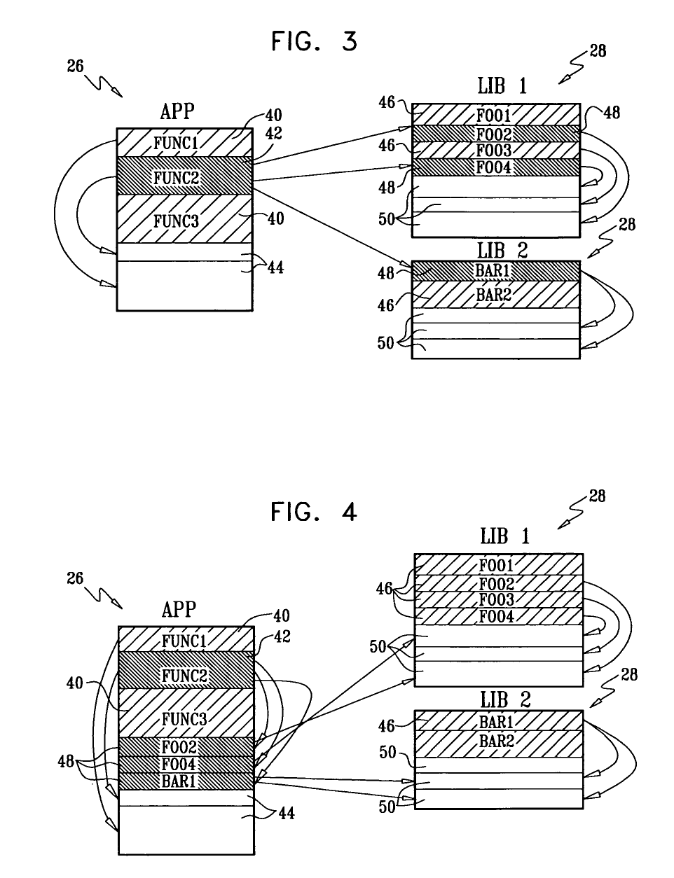

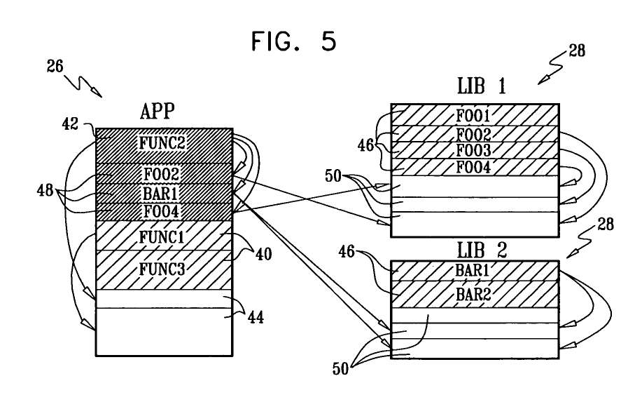

Reference is now made to FIGS. 2-5, which schematically illustrate a method for post-link code optimization, in accordance with an embodiment of the present invention. FIG. 2 is a flow chart that shows the major steps in the method. FIGS. 3-5 are block diagrams that schematically illustrate elements of application 26 and libraries 28 at successive stages in the optimization process, as explained hereinbelow.

In the simplified view of FIGS. 3-5, application 26 comprises cold functions 40 and a hot function 42, along with data blocks 44 that are accessed by the functions. (Hot functions are marked with dense hatching, while cold functions are marked with sparser hatching.) Libraries 28 similarly comprise cold functions 46, hot functions 48, and data blocks 50. FIG. 3 shows the situation pre-optimization, in which each function references data within its own module, and hot function 42 (labeled FUNC2) calls certain hot library functions 48 (FOO2, FOO4 and BAR1).

Turning now to FIG. 2, as the first step in the optimization, processor 22 obtains runtime profiles of the target module (application 26) and source modules (libraries 28), at a profiling step 30. Methods of profiling known in the art may be used to gather the profile information, but these methods are generally directed to profiling of a single module. At step 30, processor 22 combines the different profiles in order to identify hot functions in libraries 28 that are candidates for cloning into application 26. This profile is analyzed to identify the closure of each hot function, comprising other functions that are called by the hot function, as explained in detail hereinbelow.

The profile provided for each module contains an execution count of every basic block in the program and every edge of the corresponding control flow graph (CFG). An incremental disassembly method may be used to dissect the code into its basic blocks, as described in the above-mentioned articles by Haber et al. and by Henis et al., for example. For this purpose, addresses of instructions within the executable code are extracted from a variety of sources, in order to form a list of “potential entry points.” The sources typically include program/DLL entry points, the symbol table (for functions and labels), and relocation tables (through which pointers to the code can be accessed). The processor traverses the program by following the control flow starting from these entry points—while resolving all possible control flow paths—and adding newly-discovered addresses of additional potential entry points to the list, such as targets of JUMP and CALL instructions.

In the present embodiment, the “heat” of a basic block is taken to be equal to its execution count. A “frozen” basic block or function is one that has zero execution count, while a “warm” basic block is one that has executed at least once. The OOM functions in libraries 28 are selected for cloning based on their heat, which may be defined as follows for function f:

$$00 MHeat ( f ) = {\sum }_{bb ∈ T , bb \to f} heat ( bb ) \qquad ( 1 )$$

In other words, the heat of the function is defined as the sum of the heats of the basic blocks bb in target module T that branch to f. Additional factors that may be considered in selecting a function for cloning are the size of the function, number of data accesses, and number and heat of its calls to other functions, for example.

The result of equation (1) is then normalized by calculating the relative heat RH of the function, using the following formulas:

$$\begin{matrix}avgHeat = \frac{{\sum }_{wbb = 1}^{n} heat ( wbb )}{n} & ( 2 ) \\ RH ( f ) = \frac{00 MHeat ( f )}{avgHeat} & ( 3 )\end{matrix}$$

The sum in equation (2) is over the n warm basic blocks (wbb) of the target module. In computing the average heat, processor 22 considers only the warm basic blocks, since frozen blocks do not participate in the execution of the program. The higher the RH of a function f, the more frequently it is called, and the higher will be the gain of cloning the function into the target module.

Processor 22 looks up each of the OOM functions that it has selected as a candidate for cloning in the symbol table of the source modules, in order to identify the module that exports the function. After finding the initial set of hot functions in each source module (those called directly from target module), the processor calculates the hot closure HC of each of these functions, based on the profile of the source module. HC(f) is defined recursively as comprising f and all non-frozen functions called from HC. To correctly select HC, the same execution workload should be used in collecting the profiles of the target module and all source modules.

Based on the relative heats of the functions, and possibly other considerations as noted above, processor 22 selects the OOM functions to clone into the target module, at a cloning step 32. The selected function code is duplicated and copied to the target module, along with the symbols and relocations associated with the function. At this stage, the copied code of each selected function is placed in an arbitrary position in the target module, as shown in FIG. 4. In this figure, hot functions 48 have been copied to application 26 from libraries 28, while still maintaining their references to library data 50.

The copies of functions 48 are placed arbitrarily in the target module, leaving their ultimate positioning for the next stage. After copying these functions, calls to the functions from caller sites in application 26 (through the PLT stub, in the case of ELF64, for example) are replaced by direct calls to the local copy. The PLT stub then becomes redundant and can be completely removed from the target module.

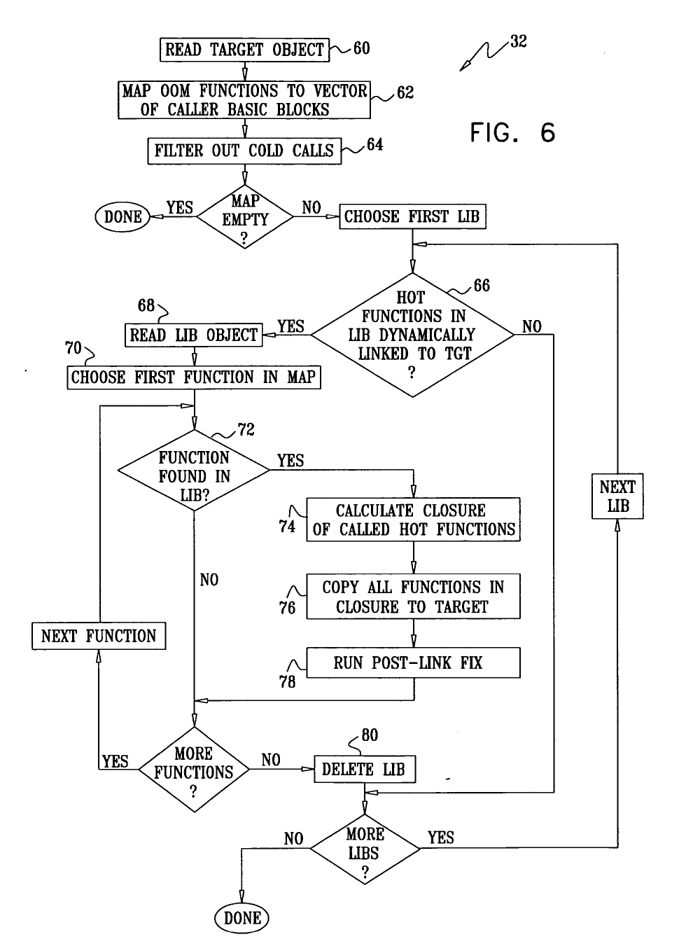

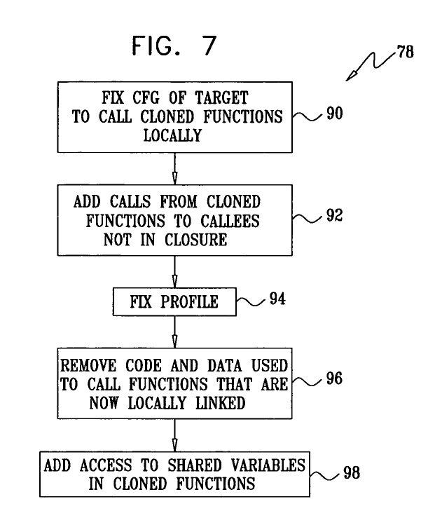

In order for cloned functions 48 to execute properly in the target module, however, additional adjustments are needed to account for the cross-module copying of the hot functions. These adjustments are described in detail hereinbelow with reference to FIGS. 6 and 7. Generally speaking, processor adjusts the imported code to comply with its new data context, by adding hooks to the expanded target module to allow correct access to shared data. The processor may also add hooks to allow imported hot functions 48, running in the target context, to access functions that were “left behind” in the source module.

In cloning functions to an application from libraries owned by another entity (such as an operating system vendor or other library supplier), it is desirable that processor 22 avoid violation of intellectual property rights. For this purpose, the processor may notify the system user of possible rights violations and may, additionally, restrict copying of functions unless the user is licensed to do so by the owner of the source module.

Furthermore, when a source module, such as a DLL, is updated to a new version, the cross-module optimization described above should be repeated in order to ensure that the optimized application is compatible with the new version.

After hot functions 48 have been copied into application 26, processor 22 applies intra-module optimization techniques in order to optimize the performance of the expanded target module, at a target optimization step 34. A possible result of this step is shown in FIG. 5, in which the hot functions are placed together in order to benefit from locality of reference. Substantially any type of intra-module optimization that is known in the art may be used at this step, such as code reordering, function inlining, and other optimization techniques that are described in the publications cited in the Background of the Invention.

Thus, the method of FIG. 2 allows traditional post-link optimizations, currently applicable only within a single module, to be used at the inter-module level. This innovation affords a wider scope of work to the optimization techniques and thus can produce more strongly optimized results. Theoretically, all the code of the source libraries could be imported into the target module (similarly to how linkers perform static linking) before optimization. This approach is generally impractical, however, because it greatly inflates the code size, which affects load time and requires a much larger page table. Embodiments of the present invention, on the other hand, import into the target module only the functions that are hot enough to contribute to improved performance if executed in the target module.

### Detailed Implementation of Function Cloning

FIG. 6 is a flow chart that schematically shows details of cloning step 32, in accordance with an embodiment of the present invention. Processor 22 reads the target object (application 26 in the present example), at a target input step 60. The processor analyzes the target object and prepares an internal structure for use in the processing that follows. The processor then maps the OOM functions called by the target object to a vector of the basic blocks in the target object that call the functions, at a function mapping step 62. Cold calls, such as calls whose relative heat is less than a selected threshold, are filtered out of the map, at a filtering step 64. If the resulting map is empty, the processor concludes that there are no hot functions to be cloned into the target object, and therefore terminates step 32.

When the map contains one or more hot functions, processor 22 cycles through each of the source objects (such as libraries 28) in turn to find and clone the appropriate OOM functions. For each library, the processor determines whether any of the hot functions in the map are present in the library, at a library assessment step 66. If the library does not contain any hot functions, the processor goes on to the next library.

If a given library does contain at least one hot function, processor 22 reads the library object, at a library reading step 68. The processor then cycles through the function names in the map until it has found each of the functions that is present in the library object, at a function finding step 72. If a given function has already been cloned to the target module (because it was in the closure of another hot function, for example), the processor skips over the function at step 72.

Processor 22 calculates the hot closure (HC, as defined above) of each new function found at step 72, at a closure calculation step 74. The processor then copies all the functions in the hot closure from the library to the target module, at a function copying step 76. In conjunction with copying a given function, the processor runs a number of post-link fixing routines, at a code fixing step 78. These routines, which are described in detail hereinbelow with reference to FIG. 7, ensure that data sharing and control flow are properly preserved between the target and source modules.

After the processor has run through all the functions in a given library, it deletes the library from the optimization list, at a deletion step 80. The processor continues in this manner until all the libraries have been processed.

FIG. 7 is a flow chart that schematically shows details of code fixing step 78, in accordance with an embodiment of the present invention. For each cloned function, processor 22 fixes the CFG of the target module to call the cloned function locally, at a CFG fixing step 90. In the case of ELF64, step 90 involves modifying the function code. (The PLT stub containing the call to the OOM function can then be deleted, as described below at step 96). The processor also adds calls from the cloned function in the target module to functions outside the target module in two cases: (1) functions that are not in the hot closure of the cloned function, and (2) functions that are located outside the source module (OOM functions). In the first case, the processor uses a descriptor located in the source module, which allows access to the required functions. In the second case, the call is directed to PLT stubs, which are cloned to the target module from the source module. Processor 22 thus preserves the correct control flow between the cloned and non-cloned functions.

After copying a function to the target module, processor 22 fixes the profile, at a profile fixing step 94. At this step, information about execution of basic blocks in the expanded target module is completed by grouping together elements of the profiles previously collected for the original source and target modules. It also removes the code and data that had been used to call functions that are now locally linked, at a code and data removal step 96. This step includes removal of PLT stubs and PLT entries that were used to contain information for calling functions in the source module, which have now been cloned to the target module.

Processor 22 deals with variables in cloned functions that are now shared between the target and source modules, at a data sharing step 98. The problem to be solved at this step can be appreciated by referring to FIG. 4, where cloned functions 48 access the same data blocks 50 in libraries 28 as do their uncloned original versions. In the case of ELF64, the solution implemented at step 98 uses the TOC anchor register mentioned above. This solution is described in detail, by way of example, in the next section of this disclosure, followed by an alternative solution for ELF32. Data sharing solutions for other target processors and operating systems will be apparent to those skilled in the art based on the systematic description and examples presented herein.

Shared Data Access in ELF64

In one embodiment of the present invention, processor 22 implements step 98 (FIG. 7) using offsets from the TOC in ELF64. The TOC contains references to all global variables of the program (including shared data) and is accessed using the TOC anchor, as explained above.

In order to provide access to data that are shared between source and target modules, two instructions are added to the prolog of the cloned function that uses the shared data, in order to save the TOC anchor of the target module and invoke a switch of the TOC anchor to the context of source module. The context is then switched back upon return from the function. Because the function is executed in the same context as it was in the library, no change is required to function code that accesses the data or to the data symbol definitions.

The switch is carried out by using a global symbol of the source library. This symbol is added to the symbol table of the target module, along with a new TOC entry that points to the symbol. When the source library is loaded, the loader updates the value of the symbol, and thus the target module is able to determine where the TOC of the library resides. As noted above, an instruction is added to the prolog of the cloned function to load the new TOC anchor. The existence of such a global symbol in the source module is assured since there would have been a symbol in the source module representing the original function (which was then cloned). This approach requires adding the load instruction only to those cloned functions that are called directly from the target module. If a cloned function B is called within a cloned function A, the context has already been switched for A, and no further treatment is required for B.

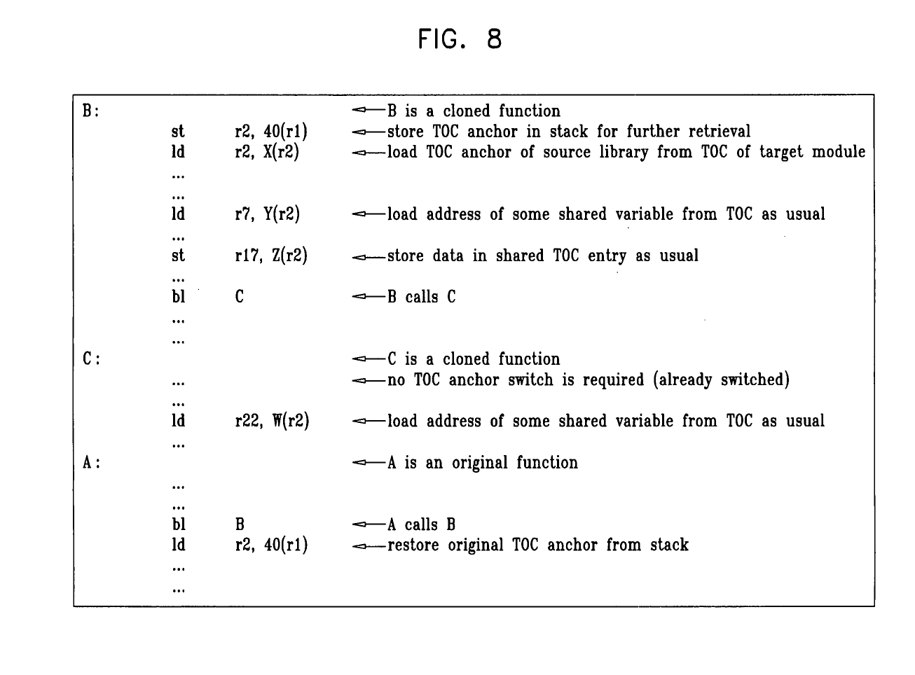

FIG. 8 is a code listing that shows an exemplary code segment of a target module after application of step 98 in the manner described above, in accordance with an embodiment of the present invention. In this listing functions B and C are cloned from a source module into the target module, which originally contained function A. Register r2 is used to hold the TOC anchor, and its contents are switched back and forth between the data contexts of the cloned and original functions.

When a cloned function A may be called directly from the target module and also from another cloned function B, it is difficult to know whether the TOC context should be switched upon calling function A. (This problem also applies when A=B, i.e., in recursive functions.) In order to avoid the problem, the call from B is directed to the original function A in the source module, rather than to the cloned A in the target module.

Shared Data Access in ELF32

Access to global data in ELF32 platforms is performed using a global offset table (GOT). The concept of the GOT is similar to the ELF64 TOC, as explained by Ho et al., in “Optimizing Performance of Dynamically Linked Programs,” USENIX 1995 Technical Conference Proceedings (New Orleans, La., 1995). The approach in ELF32 is similar, as well: a global symbol is found in the source library and a special variable is added to the target module, holding the address of the GOT of the source library. This address is updated by the loader upon allocation of address space for the library. A command to load the GOT address of the library is added to the prolog of the cloned function. Since the GOT anchor is private for the function, however, there is no need to restore it after the cloned function returns.

It will be appreciated that the embodiments described above are cited by way of example, and that the present invention is not limited to what has been particularly shown and described hereinabove. Rather, the scope of the present invention includes both combinations and subcombinations of the various features describe hereinabove, as well as variations and modifications thereof which would occur to persons skilled in the art upon reading the foregoing description and which are not disclosed in the prior art.

1. A computer-implemented method for code optimization, comprising:
collecting a profile of execution of an application program comprising a target module, which calls one or more functions in a source module, the source and target modules comprising respective, independently-linked object files;
responsively to the profile, identifying and cloning at least one function from the source module to the target module, thereby generating an expanded target module; and
restructuring the expanded target module so as to optimize the execution of the application program.

2. The method according to claim 1, wherein collecting the profile comprises generating respective execution counts of basic blocks in the target module, and computing relative heats of the one or more functions based on the execution counts of the basic blocks that call the one or more functions, and wherein identifying the at least one function comprises selecting the at least one function based on the relative heats.

3. The method according to claim 1, wherein identifying and cloning the at least one function comprises:
identifying a first function in the source module that is called from the target module;
computing a closure of the first function, which comprises at least a second function in the source module that is called by the first function; and
cloning both the first and second functions to the target module.

4. The method according to claim 3, and comprising identifying a third function in the source module that is called by the first function but is not cloned to the target module, and modifying the expanded target module so as to permit the first function to call the third function from the target module

5. The method according to claim 1, wherein cloning the at least one function comprises replacing original calls in the target module to the at least one function in the source module with new calls to the at least one cloned function in the expanded target module.

6. The method according to claim 1, wherein cloning the at least one function comprises adding to the expanded target module an invocation of a context switch so as to enable the at least one cloned function to access data in the source module.

7. The method according to claim 1, wherein the target module comprises an executable object file, and wherein the source module comprises a dynamically-linked library (DLL).

8. Apparatus for code optimization, comprising:
a memory, which is arranged to store an application program comprising a target module, which calls one or more functions in a source module, the source and target modules comprising respective, independently-linked object files; and
a code processor, which is arranged to collect a profile of execution of the application and, responsively to the profile, to identify and clone at least one function from the source module to the target module, thereby generating an expanded target module, and to restructure the expanded target module so as to optimize the execution of the application program.

9. The apparatus according to claim 8, wherein the profile comprises respective execution counts of basic blocks in the target module, and wherein the code processor is arranged to compute relative heats of the one or more functions based on the execution counts of the basic blocks that call the one or more functions, and to select the at least one function for cloning based on the relative heats.

10. The apparatus according to claim 8, wherein the code processor is arranged to identify a first function in the source module that is called from the target module, to compute a closure of the first function, which comprises at least a second function in the source module that is called by the first function, and to clone both the first and second functions to the target module.

11. The apparatus according to claim 10, wherein the code processor is arranged to identify a third function in the source module that is called by the first function but is not cloned to the target module, and modifying the expanded target module so as to permit the first function to call the third function from the target module

12. The apparatus according to claim 8, wherein the code processor is arranged to replace original calls in the target module to the at least one function in the source module with new calls to the at least one cloned function in the expanded target module.

13. The apparatus according to claim 8, wherein the code processor is arranged to add to the expanded target module an invocation of a context switch so as to enable the at least one cloned function to access data in the source module.

14. A computer software product, comprising a computer-readable medium in which program instructions are stored, which instructions, when read by a computer, cause the computer to collect a profile of execution of an application program comprising a target module, which calls one or more functions in a source module, the source and target modules comprising respective, independently-linked object files, and responsively to the profile, to identify and clone at least one function from the source module to the target module, thereby generating an expanded target module, and to restructure the expanded target module so as to optimize the execution of the application program.

15. The product according to claim 14, wherein the profile comprises respective execution counts of basic blocks in the target module, and wherein the instructions cause the computer to compute relative heats of the one or more functions based on the execution counts of the basic blocks that call the one or more functions, and to select the at least one function for cloning based on the relative heats.

16. The product according to claim 14, wherein the instructions cause the computer to identify a first function in the source module that is called from the target module, to compute a closure of the first function, which comprises at least a second function in the source module that is called by the first function, and to clone both the first and second functions to the target module.

17. The product according to claim 16, wherein the instructions cause the computer to identify a third function in the source module that is called by the first function but is not cloned to the target module, and modifying the expanded target module so as to permit the first function to call the third function from the target module

18. The product according to claim 14, wherein the instructions cause the computer to replace original calls in the target module to the at least one function in the source module with new calls to the at least one cloned function in the expanded target module.

19. The product according to claim 14, wherein the instructions cause the computer to add to the expanded target module an invocation of a context switch so as to enable the at least one cloned function to access data in the source module.

20. The product according to claim 14, wherein the target module comprises an executable object file, and wherein the source module comprises a dynamically-linked library (DLL).
